(19) United States
(12) Patent Application Publication
(10) Pub. No.: US 2025/0383031 A1
(43) Pub. Date: Dec. 18, 2025

(54) ELECTROMAGNET DEVICE AND VALVE

(71) Applicant: ETO GRUPPE TECHNOLOGIES GmbH, Stockach (DE)

(72) Inventors: Mariusz BUNIO, Zerniki Male (PL); Witold Bruczuk, Wroclaw (PL)

(21) Appl. No.: 19/233,590

(22) Filed: Jun. 10, 2025

(30) Foreign Application Priority Data
Jun. 14, 2024 (DE) 10 2024 116 839.0

(51) Int. Cl. F16K 31/06; H02K 26/00

(52) U.S. Cl. CPC F16K 31/0675; H02K 26/00

(57) ABSTRACT

An electromagnet device has at least one coil body, has a magnetic coil wound on the coil body, and has a magnetic circuit comprising at least a magnetic core, a magnet armature, and a magnetic yoke unit with at least one magnet armature-side yoke part and with at least one magnetic core-side yoke part realized separately from the magnet armature-side yoke part, the magnet armature-side yoke part being configured to guide a magnetic flux, which can be generated by the magnetic coil, between the magnetic core-side yoke part and the magnet armature. The electromagnet device further includes a yoke sealing unit, with at least one first sealing element, and with at least one second sealing element bearing in a sealing manner against the magnet armature-side yoke part on a second side of the magnet armature-side yoke part that is situated opposite the first side.

### CORRESPONDENCE WITH RELATED APPLICATION

This U.S. patent application is based on and claims priority to German patent application DE 10 2024 116 839.0, filed on Jun. 14, 2024.

### Prior Art

The invention concerns an electromagnet device and a valve.

An electromagnet device with at least one coil body, with a magnetic coil wound on the coil body, and with a magnetic circuit comprising at least a magnetic core, a magnet armature supported movably relative to the magnetic core, and a magnetic yoke unit with at least one magnet armature-side yoke part, and with at least one magnetic core-side yoke part realized separately from the magnet armature-side yoke part, the magnet armature-side yoke part being configured to guide a magnetic flux that can be generated by the magnetic coil between the magnetic core-side yoke part and the magnet armature, has already been proposed. The objective of the invention is in particular to provide a generic device with advantageous energy efficiency. The objective is achieved according to the invention.

### Advantages of the Invention

The invention is based on an electromagnet device with at least one coil body, with a magnetic coil wound on the coil body, and with a magnetic circuit comprising at least a magnetic core, a magnet armature supported movably relative to the magnetic core, and a magnetic yoke unit with at least one magnet armature-side yoke part, and with at least one magnetic core-side yoke part realized separately from the magnet armature-side yoke part, wherein the magnet armature-side yoke part is configured to guide a magnetic flux/magnetic field that can be generated by the magnetic coil between the magnetic core-side yoke part and the magnet armature.

It is proposed that the electromagnet device comprises a yoke sealing unit, in particular at least for sealing a movement range of the magnet armature/an armature guiding range of the coil body, with at least one first sealing element bearing against the magnet armature-side yoke part on a first side of the magnet armature-side yoke part in a sealing manner, preferably in a gas-tight manner, and with at least one second sealing element bearing against the magnet armature-side yoke part on a second side of the magnet armature-side yoke part that is situated opposite the first side in a sealing manner, preferably in a gas-tight manner. This advantageously enables a more compact design, which in particular comprises fewer different individual components and/or which in particular allows smaller distances between the magnet armature, the magnetic coil and the yoke unit. It is advantageously possible to obtain a particularly narrow magnetic circuit. As a result, while maintaining sufficiently high magnetic forces, it is advantageously possible to achieve a size reduction of a coil winding and thus of copper consumption (by approximately 30%) and of current consumption. The sealing of the magnet armature-side yoke part by the yoke sealing unit advantageously allows dispensing with a separate (sealed) core tube/armature guiding tube between the magnet armature and the yoke unit.

The magnetic coil is in particular realized as a copper wire wound onto the coil body. The magnetic circuit is preferably realized as a magnetic circuit which is at least largely closed, preferably completely closed except for a reluctance gap and production tolerances. The magnetic core is in particular arranged in the electromagnet device in a position-fixed manner with respect to the coil body and/or to the magnetic coil. The magnetic core preferably comprises a soft-magnetic material having a high magnetic saturation flux density and a high magnetic permeability, for example an iron, a ferromagnetic metal alloy or a ferrimagnetic material. The magnetic core is in particular configured for a (low-loss) bundling of a magnetic flux that is generated if the magnetic coil is energized. The magnet armature may be realized from a material that is the same as or similar to the material of the magnetic core. The magnet armature is preferably (depending on the energization of the magnetic coil) linearly movable towards the magnetic core or linearly movable away from the magnetic core. The magnetic yoke unit preferably realizes a magnetic return path between the magnet armature and the magnetic core. The magnet armature-side yoke part is configured to guide the magnetic flux, which is generated when the magnetic coil is energized, between the magnet armature and the magnetic core-side yoke part. The magnet armature-side yoke part preferably contacts the magnetic core-side yoke part with at least one surface subregion. The magnet armature-side yoke part preferably almost contacts the magnet armature. Preferably, only a minimal air gap is arranged between a surface subregion of the magnet armature-side yoke part, which almost contacts the magnet armature, and the magnet armature. The magnetic core-side yoke part is configured to guide the magnetic flux, which is generated when the magnetic coil is energized, between the magnetic core and the magnet armature-side yoke part. The magnetic core-side yoke part preferably contacts the magnet armature-side yoke part with at least one surface subregion.

The magnetic core-side yoke part preferably contacts the magnetic core in a surface subregion of the magnetic core-side yoke part.

The yoke sealing unit is in particular configured to create a fluid-tight, preferably gas-tight, sealing at least of the movement range of the magnet armature. The movement range of the magnet armature is preferably not sealed against a flow-through region of a valve comprising the electromagnet device, which is switchable by means of the magnet armature. The yoke sealing unit is therefore preferably also configured to seal the flow-through region of the valve comprising the electromagnet device. “Configured” is in particular to mean specifically programmed, designed and/or equipped. By an object being configured for a specific function is in particular to be understood that the object fulfils and/or carries out this specific function in at least one application state and/or operation state. The first sealing element is realized and arranged completely circumferentially around a movement axis of the magnet armature/around the movement range of the magnet armature. The second sealing element is realized and arranged completely circumferentially around a movement axis of the magnet armature/around the movement range of the magnet armature. The first sealing element and/or the second sealing element extend/extends in a radial plane that is perpendicular to the movement axis of the magnet armature. The first sealing element preferably bears against an outer side of the magnet armature-side yoke part. The first side of the magnet armature-side yoke part is preferably the outer side of the magnet armature-side yoke part. The second sealing element preferably bears against an inner side of the magnet armature-side yoke part. The second side of the magnet armature-side yoke part is preferably the inner side of the magnet armature-side yoke part. Alternatively, however, the first side and the second side could also be the upper side and the underside of the magnet armature-side yoke part. The second sealing element preferably extends within the first sealing element. The sealing elements are in particular arranged coaxially with one another. The sealing elements may both be situated in a common radial plane (relative to the movement axis of the magnet armature or to a respective dedicated central axis) or they may be situated in different radial planes which are parallel to one another.

In a further aspect of the invention, which may be considered on its own or also in combination with at least one, in particular in combination with one, in particular in combination with any number of the other aspects of the invention, it is proposed that the magnet armature-side yoke part is realized as an at least one-stepped yoke disk, preferably as a precisely one-stepped yoke disk. This advantageously allows achieving a high degree of energy efficiency, in particular by advantageous magnetic flux guidance and/or by enabling effective axial sealing of the movement range of the magnet armature toward the outside, which in turn enables a more compact implementation of the electromagnet device. The magnet armature-side yoke part is preferably stepped in the axial direction. The axial direction is preferably oriented parallel to a central axis of the (rotationally symmetrical) magnet armature-side yoke part and/or to the movement axis of the magnet armature. The at least one-stepped yoke disk/the magnet armature-side yoke part preferably has at least two subregions, which are separate from one another and are in particular arranged on different steps and in which the respective surfaces of the magnet armature-side yoke part extend parallel to one another and perpendicular to the central axis of the (rotationally symmetrical) magnet armature-side yoke part and/or to the movement axis of the magnet armature. In particular, a further surface of the magnet armature-side yoke part is situated between these two surfaces and extends perpendicular to the two other surfaces and/or parallel to the central axis of the (rotationally symmetrical) magnet armature-side yoke part and/or to the movement axis of the magnet armature. A “yoke disk” is in particular to mean a component which, in a designated installation position, has a maximum extent in a radial direction (perpendicular to the movement axis of the magnet armature) that is substantially greater than a maximum extent of the component perpendicular thereto in the axial direction (parallel to the movement axis of the magnet armature). It is conceivable that the magnet armature-side yoke part is stepped twice, stepped three times or stepped more than three times, but the magnet armature-side yoke part is preferably precisely only one-stepped. Furthermore, it is proposed that the first sealing element and/or the second sealing element are/is realized as a radial sealing element. This advantageously allows obtaining an axial seal, in particular with the above-described advantages associated therewith. The radial sealing elements are preferably sealing rings, e.g. O-rings or profiled sealing rings. The central axes of the radial sealing elements are preferably oriented parallel to the movement axis of the magnet armature. The central axes of the radial sealing elements preferably overlap with a central axis of the armature guiding range of the coil body/of the movement range of the magnet armature. The radial sealing elements prevent an axial flow of fluid beyond the radial sealing elements. With the exception of the radii, the two sealing elements may be realized identically; the two sealing elements may in particular have identical cross-sectional areas.

It is moreover proposed that in a middle region situated between two radial end regions, the magnet armature-side yoke part forms a sealing section within which the first sealing element and the second sealing element bear sealingly against the magnet armature-side yoke part. This advantageously allows achieving simple assembly and/or a high and reliable sealing effect. In particular, the two sealing elements are arranged in a middle region of the stepped yoke disk. A respective radial end region of the magnet armature-side yoke part in particular extends, starting from a respective radial end edge, over at least 5%, preferably at least 10%, preferentially at least 15% and particularly preferentially at most 25%, of a total surface, in particular a main surface that is different from edge faces, of the magnet armature-side yoke part. The middle region is preferably free of overlap with the radial end regions.

It is further proposed that within the sealing section, surfaces of the magnet armature-side yoke part extend axially, in particular at least substantially parallel, to a movement axis of the magnet armature and/or to central axes of the sealing elements. This advantageously allows obtaining an axial sealing, in particular with the above-described advantages associated therewith. “Substantially parallel” is here in particular to mean an orientation of a direction relative to a reference direction, in particular in a plane, wherein the direction differs from the reference direction in particular by less than 8°, advantageously by less than 5° and particularly advantageously by less than 2°. Where the sealing elements are arranged, the surfaces of the stepped yoke disk preferably extend vertically. The (outer) first sealing element thus preferably surrounds the (inner) second sealing element.

If moreover surfaces of the magnet armature-side yoke part, which are different from end edge faces of the magnet armature-side yoke part, extend within the two radial end regions radially, in particular at least substantially perpendicularly to a movement axis of the magnet armature, advantageous magnetic flux guidance is achievable, which in particular allows achieving a compact design and/or a reduction of copper material in the magnetic coil. The ends of the stepped yoke disk preferably point in the radial direction.

Beyond this, it is proposed that a surface of the magnet armature-side yoke part, which is in particular different from an end edge face of the magnet armature-side yoke part, bears against and contacts the magnet core-side yoke part within one of the two radial end regions. This allows achieving advantageous magnetic flux guidance, which in particular allows achieving a compact design and/or a reduction of copper material in the magnet coil.

It is further proposed that a surface of the magnet armature-side yoke part, which forms an end edge face of the magnet armature-side yoke part within one of the two radial end regions, forms a guiding surface for guiding an axial movement of the magnet armature. This allows achieving advantageous magnetic flux guidance and/or a compact design. In particular, the magnet armature-side yoke part delimits the movement range of the magnet armature directly. Preferably, no further physical elements are arranged between the surface of the magnet armature-side yoke part which faces the magnet armature and which forms the end edge face of the magnet armature-side yoke part within the radial end region, and the magnet armature.

Beyond this, it is proposed that the magnet armature is guided directly in the coil body, and preferably without core tubes, armature guiding tubes or the like. This advantageously allows achieving a compact design, which advantageously allows a reduction of winding material of the magnetic coil and a reduction of the energy required for operation, in particular without causing functional impairment. In particular, a surface of the coil body that delimits the movement range of the magnet armature is area-wise flush with the surface of the magnet armature-side yoke part that faces towards the magnet armature and forms the end edge face of the magnet armature-side yoke part within the radial end region.

It is also proposed that the electromagnet device comprises one or several airing and/or de-airing groove/s, which permits/permit air flowing axially past the magnet armature and which is/are sealed at least indirectly against the outside by the yoke sealing unit. This advantageously allows integrating an airing and de-airing function into the compact design with the aforementioned advantages in terms of material efficiency and energy efficiency. The yoke sealing unit in particular ensures that air (apart from valve connections) can only escape from the valve comprising the electromagnet device via the airing and/or de-airing grooves. If one or several airing and/or de-airing groove/s, preferably all airing and/or de-airing grooves, is/are arranged in the coil body, it is advantageously possible to maximize a magnetic force, in particular as the magnetic flux-guiding material of the magnet armature can maximally fill the movement range of the magnet armature. Advantageously, the magnet armature can be realized free of airing and/or de-airing grooves. In particular, the coil body comprises two airing and/or de-airing grooves, three airing and/or de-airing grooves, four airing and/or de-airing grooves or more than four airing and/or de-airing grooves. In particular, the airing and/or de-airing grooves are arranged in a regular manner around the movement range of the magnet armature. The airing and/or de-airing grooves of the coil body are preferably straight-lined. The airing and/or de-airing grooves of the coil body preferably have a constant groove cross section in the axial direction. The airing and/or de-airing grooves preferably extend over a total axial extent of a region of the coil body that delimits the movement range of the magnet armature directly. In particular, the airing and/or de-airing grooves of the coil body open at one end into a reluctance gap of the magnetic circuit.

If herein the one or several airing and/or de-airing groove/s is/are continued in the magnet armature-side yoke part, effective airing and/or de-airing of the magnet armature is advantageously achievable. Moreover, a large portion of the magnet armature-side yoke part (in particular the edge regions of the magnet armature-side yoke part that face towards the movement range of the magnet armature outside the airing and/or de-airing grooves) can advantageously be brought as close as possible to the magnet armature. This advantageously allows achieving particularly efficient magnetic flux guidance. In particular, the magnet armature-side yoke part has, in the radial end region that faces towards the movement range of the magnet armature, airing and/or de-airing recesses which directly adjoin the airing and/or de-airing grooves of the coil body, such that preferably an, in particular at least substantially deflection-free, flow of air is enabled between the airing and/or de-airing grooves and the airing and/or de-airing recesses. In particular, the magnet armature-side yoke part has a number of airing and/or de-airing recesses which corresponds to the number of airing and/or de-airing grooves of the coil body. In particular, the airing and/or de-airing grooves, preferably the airing and/or de-airing recesses of the magnet armature-side yoke part, open at one end into a flow-through region of a valve comprising the electromagnet device.

Furthermore, it is proposed that the magnet armature forms a cylindrical, in particular groove-free, preferably planar, running surface, in particular cylinder shell running surface. This advantageously allows maximizing a magnetic force, in particular as the magnetic flux-guiding material of the magnet armature can maximally fill the movement range of the magnet armature. Moreover, particularly simple and cost-effective production of the magnet armature is enabled. Alternatively to the arrangement of the airing and/or de-airing grooves in the coil body, it is proposed that one or several airing and/or de-airing groove/s, preferably all airing and/or de-airing grooves, is/are arranged in the magnet armature. This advantageously allows achieving a particularly simple and cost-effective design of the coil body. Moreover, the magnet armature-side yoke part may advantageously be realized free of airing and/or de-airing recesses. Advantageously, particularly close approach of the entire edge region of a radial end of the magnet armature-side yoke part to the movement range of the magnet armature is enabled. In particular, the magnet armature comprises two airing and/or de-airing grooves, three airing and/or de-airing grooves, four airing and/or de-airing grooves or more than four airing and/or de-airing grooves. In particular, the airing and/or de-airing grooves are arranged in a regular manner around the magnet armature. The airing and/or de-airing grooves of the magnet armature are preferably straight-lined. The airing and/or de-airing grooves of the magnet armature preferably have a constant groove cross section in the axial direction. The airing and/or de-airing grooves preferentially extend over a total axial extent of the magnet armature. In particular, the airing and/or de-airing grooves of the magnet armature open at one end into a reluctance gap of the magnetic circuit. In particular, the airing and/or de-airing grooves of the magnet armature open at one end into the flow-through region of the valve comprising the electromagnet device.

Alternatively, it is also conceivable that the magnet armature and the coil body comprise airing and/or de-airing grooves which may overlap with one another or may be free of overlap with one another. This advantageously allows adjusting the respectively aforementioned advantages of the two alternatives.

In addition, it is proposed that the magnetic core-side yoke part is realized as a U-yoke. This allows achieving an advantageous construction. Advantageously, good, effective and/or compact magnetic flux guidance is achievable. In particular, a maximum axial extent of the U-yoke (parallel to the movement axis of the magnet armature) is substantially greater than a maximum radial extent of the U-yoke perpendicular thereto. The U-yoke preferably engages at least around the magnetic core on two opposite-situated sides, in particular radial sides. In particular, an axial end region of the magnetic core penetrates the U-yoke in the axial direction. The U-yoke has a recess that is provided for this purpose.

It is further proposed that the magnetic core comprises an axial airing and/or de-airing channel, which in particular permits an axial forwarding of air emerging from the one or several airing and/or de-airing groove/s. In this way, effective airing of the magnet armature is advantageously achievable. Advantageously, a high degree of mobility of the magnet armature is achievable. The airing and/or de-airing channel preferably extends centrally through the magnetic core. The airing and/or de-airing channel preferably has approximately the same cross-section as or a larger cross-section than the airing and/or de-airing grooves taken together. Beyond this it is proposed that the electromagnet device comprises a one-part/monolithic de-airing cap, which permits an escape of air, emerging from the axial airing and/or de-airing channel of the magnetic core, from the electromagnet device to the outside and at the same time prevents air from entering the electromagnet device from the outside. This allows creating an advantageous de-airing function for the electromagnet device. Advantageously, it can be ensured by the yoke sealing unit that a de-airing takes place exclusively via the de-airing cap. The de-airing cap is arranged adjacently to an end of the airing and/or de-airing channel that points away from the magnet armature.

It is moreover proposed that the electromagnet device comprises a magnetic core sealing unit, which seals the magnetic core towards the coil body. This advantageously allows avoiding leakage. It is advantageously possible to make sure that de-airing takes place only via the path of airing and/or de-airing groove—airing and/or de-airing channel—de-airing cap. The magnetic core sealing unit is in particular realized differently and separately from the yoke sealing unit. The magnetic core sealing unit is in particular arranged in an end region of the electromagnet device that faces away from the magnet armature, while the yoke sealing unit is arranged in an end region of the electromagnet device that faces towards the magnet armature. The magnetic core sealing unit in particular bears in a sealing manner, preferably in a gas-tight manner, against a surface of the magnetic core. The magnetic core sealing unit in particular bears in a sealing manner, preferably in a gas-tight manner, against a surface of the coil body that faces towards the magnetic core. The magnetic core sealing unit is preferably realized as a radial seal, in particular as a sealing ring.

Furthermore, a valve, in particular an airing and/or de-airing valve for a pneumatic system, for example of a vehicle such as a truck or the like, with an electromagnet comprising the electromagnet device, is proposed. This advantageously allows providing a valve with the aforementioned advantages. The valve is preferably a 3/2-way valve. Alternatively, however, the valve could be a 2/2-way valve. In a currentless state, the valve is closed. Alternatively, however, the valve could also be realized so as to be open in a currentless state.

The electromagnet device according to the invention and the valve according to the invention shall here not be limited to the above-described application and implementation. In particular, in order to fulfil a functionality that is described here, the electromagnet device according to the invention and the valve according to the invention may have a number of individual elements, components and units that differs from a number given here.

### DRAWINGS

Further advantages will become apparent from the following description of the drawings. Two exemplary embodiments of the invention are shown in the drawings. The drawings, the description and the claims contain numerous features in combination. Someone skilled in the art will purposefully also consider the features individually and will find further expedient combinations.

In the drawings:

FIG. 1 shows two schematic sectional views of a valve, with an electromagnet comprising an electromagnet device, and

FIG. 2 shows two schematic sectional views of a valve, with an electromagnet comprising an alternative electromagnet device.

### DESCRIPTION OF THE EXEMPLARY EMBODIMENTS

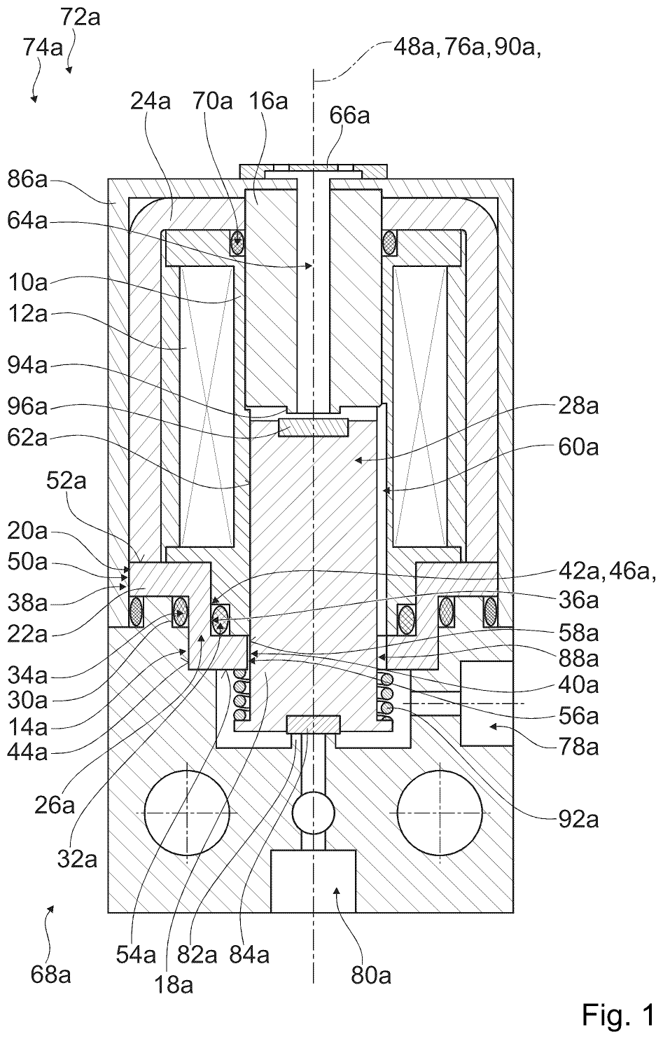

FIG. 1 shows schematically two sectional views of a valve 72a. The sectional views are separated by a line 76a. A vertical section through one half of the valve 72a is shown to the left of the line 76a. To the right of the line 76a, likewise a section through one half of the valve 72a is shown, wherein the section to the right of the line 76a is made perpendicular to the section to the left of the line 76a. The valve 72a is embodied as an airing and/or de-airing valve for a pneumatic system. The valve 72a comprises an electromagnet 74a. The electromagnet 74a is an electromagnetic reluctance actuator. The electromagnet 74a comprises an electromagnet device 68a. By way of example, the electromagnet device 68a completely realizes the electromagnet 74a. The electromagnet device 68a comprises a coil body 10a. The electromagnet device 68a comprises a magnetic coil 12a. The magnetic coil 12a is wound on the coil body 10a. The electromagnet device 68a comprises a magnet armature 18a. The electromagnet device 68a comprises a magnetic core 16a. The magnet armature 18a is supported movably. The magnet armature 18a is supported so as to be linearly movable along a movement axis 48a. The magnet armature 18a is supported movably relative to the magnetic core 16a. The magnet armature 18a is guided directly in the coil body 10a. The magnet armature 18a is guided independently of core tubes, armature guiding tubes or the like. The electromagnet device 68a is free of magnet armature guiding elements realized separately from the coil body 10a, such as core tubes, armature guiding tubes or the like. The coil body 10a at least partly forms a movement range 28a for the magnet armature 18a. The coil body 10a delimits at least a portion of the movement range 28a of the magnet armature 18a directly. The movement range 28a is a hollow space in which the magnet armature 18a can, preferably linearly, move.

The valve 72a comprises two valve ports 78a, 80a. The magnet armature 18a is configured to selectively close or release the connection between the two valve ports 78a, 80a. The valve 72a comprises a valve seat 82a. The magnet armature 18a comprises a valve seal 84a. Via the movement of the magnet armature 18a in the movement range 28a, which can be generated by the magnetic field of the magnetic coil 12a, the connection between the two valve ports 78a, 80a can be closed by the valve seal 84a being seated on the valve seat 82a and can be opened by the valve seal 84a being lifted from the valve seat 82a. The valve 72a comprises a valve housing 86a. The valve housing 86a encloses the components of the electromagnet device 68a.

The electromagnet device 68a comprises a magnetic circuit 14a. The magnetic circuit 14a comprises the magnet armature 18a. The magnetic circuit 14a comprises the magnetic core 16a. The magnetic circuit 14a comprises a magnetic yoke unit 20a. The magnetic yoke unit 20a comprises a magnet armature-side yoke part 22a and a magnetic core-side yoke part 24a that is realized separately from the magnet armature-side yoke part 22a. The magnet armature-side yoke part 22a is realized as a precisely one-stepped yoke disk. The magnetic core-side yoke part 24a is realized as a U-yoke. In the exemplary embodiment shown, no further yoke parts are provided. However, it is conceivable that the magnetic yoke unit 20a comprises more than two separate yoke parts 22a, 24a. The magnetic coil 12a generates a magnetic flux/a magnetic field when energized. Depending on the magnetic flux, the magnet armature 18a is moved/one of a plurality of magnet armature positions is set. The magnet armature-side yoke part 22a is configured to guide the magnetic flux generated by the magnetic coil 12a between the magnetic core-side yoke part 24a and the magnet armature 18a. The magnetic core-side yoke part 24a is configured to guide the magnetic flux generated by the magnetic coil 12a between the magnet armature-side yoke part 24a and the magnetic core 16a.

The electromagnet device 68a comprises a yoke sealing unit 26a. The yoke sealing unit 26a is configured for a sealing of the movement range 28a of the magnet armature 18a. The yoke sealing unit 26a comprises a first sealing element 30a. The first sealing element 30a is realized as a radial sealing element. The first sealing element 30a bears in a sealing manner against the magnet armature-side yoke part 22a on a first side 34a of the magnet armature-side yoke part 22a. The yoke sealing unit 26a comprises a second sealing element 32a. The second sealing element 32a is realized as a radial sealing element. The second sealing element 32a bears in a sealing manner against the magnet armature-side yoke part 22a on a second side 36a of the magnet armature-side yoke part 22a that is situated opposite the first side 34a. The electromagnet device 68a further comprises a magnetic core sealing unit 70a. The magnetic core sealing unit 70a is realized differently and separately from the yoke sealing unit 26a. The magnetic core sealing unit 70a seals the magnetic core 16a towards the coil body 10a. The magnetic core sealing unit 70a is realized as an annular radial sealing means. The magnet armature-side yoke part 22a forms a sealing section 46a. The first sealing element 30a bears sealingly against the magnet armature-side yoke part 22a within the sealing section 46a. The second sealing element 32a bears sealingly against the magnet armature-side yoke part 22a within the sealing section 46a. The sealing section 46a is situated in a middle region 42a of the magnet armature-side yoke part 22a. The middle region 42a is located between two opposite-situated radial end regions 38a, 40a of the magnet armature-side yoke part 22a. Surfaces 44a of the magnet armature-side yoke part 22a within the sealing section 46a extend axially. The surfaces 44a of the magnet armature-side yoke part 22a within the sealing section 46a extend parallel to the movement axis 48a of the magnet armature 18a. Surfaces 52a, 54a of the magnet armature-side yoke part 22a, which are situated within the two radial end regions 38a, 40a of the magnet armature-side yoke part 22a and which are different from end edge faces 50a, 56a of the magnet armature-side yoke part 22a, extend radially. The surfaces 52a, 54a of the magnet armature-side yoke part 22a, which are situated within the two radial end regions 38a, 40a of the magnet armature-side yoke part 22a and which are different from end edge faces 50a, 56a of the magnet armature-side yoke part 22a, extend perpendicularly to the movement axis 48a of the magnet armature 18a. A surface 52a of the surfaces 52a, 54a of the magnet armature-side yoke part 22a, which are different from the end edge faces 50a, 56a of the magnet armature-side yoke part 22a, bears against and contacts the magnet core-side yoke part 24a within the associated radial end region 38a. A further surface 58a of the magnet armature-side yoke part 22a, which forms an end edge face 56a of the magnet armature-side yoke part 22a within a radial end region 40a of the two radial end regions 38a, 40a that faces the magnet armature 18a, at the same time also forms a guiding surface for guiding the axial movements of the magnet armature 18a.

The electromagnet device 68a comprises an airing and/or de-airing groove 60a (cf. right-hand side of FIG. 1). In principle, the electromagnet device 68a comprises further airing and/or de-airing grooves 60a, which are realized identically. For the sake of simplicity, however, the properties of the airing and/or de-airing grooves 60a will be described below for an individual airing and/or de-airing groove 60a, which is to be taken by way of example for all further airing and/or de-airing grooves 60a that may be present. The airing and/or de-airing groove 60a allows air flowing axially past the magnet armature 18a. The airing and/or de-airing groove 60a is at least indirectly sealed against the outside by the yoke sealing unit 26a. The yoke sealing unit 26a ensures that the air that does not flow between the valve ports 78a, 80a flows away through the airing and/or de-airing groove 60a and does not escape from the valve 72a via other paths. The airing and/or de-airing groove 60a is arranged exclusively in the coil body 10a. The magnet armature 18a is free of airing and/or de-airing grooves 60a. The magnet armature 18a comprises a cylindrical groove-free running surface 62a. The airing and/or de-airing groove 60a is continued in the magnet armature-side yoke part 22a. The magnet armature-side yoke part 22a has an airing and/or de-airing recess 88a. The airing and/or de-airing recess 88a continues the airing and/or de-airing groove 60a of the coil body 10a only in the cross-sectional region of the airing and/or de-airing groove 60a. The cross-sections of the airing and/or de-airing groove 60a and of the airing and/or de-airing recess 88a overlap.

The magnetic core 16a comprises an axial airing and/or de-airing channel 64a. The airing and/or de-airing channel 64a permits an axial forwarding of air emerging from the airing and/or de-airing groove 60a on a side of the magnet armature 18a that faces towards the magnetic core 16a. The airing and/or de-airing channel 64a completely penetrates the magnetic core 16a in an axial direction 90a of the electromagnet device 68a. The axial direction 90a is parallel to the movement axis 48a of the magnet armature 18a. Central axes of the sealing elements 30a, 32a/sealing means of the yoke sealing unit 26a and of the magnetic core sealing unit 70a are likewise parallel to the axial direction 90a. The electromagnet device 68a comprises a de-airing cap 66a. The de-airing cap 66a is realized in a one-part implementation. The de-airing cap 66a is arranged in a de-airing path of the electromagnet device 68a downstream of the airing and/or de-airing channel 64a and of the airing and/or de-airing groove 60a. The de-airing cap 66a permits an escape of air, emerging from the axial airing and/or de-airing channel 64a of the magnetic core 16a, from the electromagnet device 68a to the outside. The de-airing cap 66a at the same time prevents air from entering the electromagnet device 68a from the outside.

The electromagnet device 68a comprises a mechanical reset element 92a. In a currentless state, the reset element 92a is configured to deflect the magnet armature 18a into a basic position. FIG. 1 exemplarily shows the basic position. By way of example, the reset element 92a is realized as a compression spring. In the basic position, the valve seal 84a is seated on the valve seat 82a and closes the connection between the two valve ports 78a, 80a. At the same time, a de-airing between one of the valve ports 78a and the de-airing cap 66a is possible via the airing and/or de-airing channel 64a and the airing and/or de-airing groove 60a. The magnetic core 16a realizes a further valve seat 94a. The magnet armature 18a comprises a further valve seal 96a. The further valve seal 96a is arranged on a side of the magnet armature 18a that is situated opposite the valve seal 84a. By the further valve seal 96a being seated on the further valve seat 94a, the airing and/or de-airing channel 64a of the magnetic core 16a can be closed. The further valve seat 94a is arranged at an inlet of the airing and/or de-airing channel 64a. When the magnetic coil 12a is energized, the magnet armature 18a is pulled into the magnetic coil 12a, such that the further valve seal 96a sits sealingly on the further valve seat 94a and thus closes the airing and/or de-airing channel 64a. As a result, a de-airing via the de-airing cap 66a and/or the airing and/or de-airing groove 60a is no longer possible. However, at the same time a flow connection between the two valve ports 78a, 80a is opened by the valve seal 84a being lifted from the valve seat 82a.

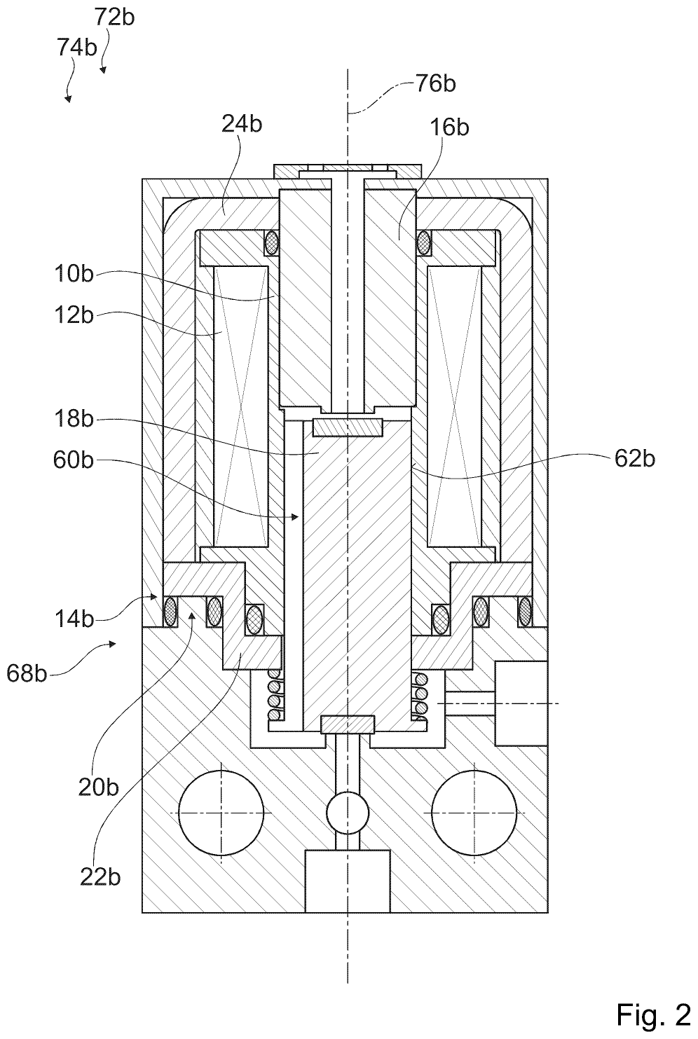

In FIG. 2 a further exemplary embodiment of the invention is shown. The following description and the drawing are substantially limited to the differences between the exemplary embodiments, wherein with regard to components having the same denomination, in particular with regard to components having the same reference numerals, reference may in principle also be made to the drawings and/or the description of the other exemplary embodiment, in particular of FIG. 1. To distinguish between the exemplary embodiments, the letter a has been added to the reference numerals of the exemplary embodiment in FIG. 1. In the exemplary embodiment of FIG. 2 the letter a has been replaced by the letter b.

FIG. 2 shows schematically two sectional views of a valve 72b. The sectional views are separated by a line 76b. To the left of the line 76b a vertical section through one half of the valve 72b is shown. To the right of the line 76b likewise a section through one half of the valve 72b is shown, wherein the section to the right of the line 76b has been made perpendicular to the section to the left of the line 76b.

The valve 72b comprises an electromagnet 74b with an alternative electromagnet device 68b. The alternative electromagnet device 68b comprises a coil body 10b with a magnetic coil 12b wound on the coil body 10b. The alternative electromagnet device 68b includes a magnetic circuit 14b with a magnet armature 18b, a magnetic core 16b and a magnetic yoke unit 20b comprising a magnet armature-side yoke part 22b and a magnetic core-side yoke part 24b. The alternative electromagnet device 68b comprises an airing and/or de-airing groove 60b (cf. left-hand side of FIG. 2). In principle, the alternative electromagnet device 68b comprises further airing and/or de-airing grooves 60b, which are realized identically. For the sake of simplicity, however, the properties of the airing and/or de-airing grooves 60b will be described below for an individual airing and/or de-airing groove 60b, which is to be taken by way of example for all further airing and/or de-airing grooves 60b that may be present. The airing and/or de-airing groove 60b permits air flowing axially past the magnet armature 18b. The airing and/or de-airing groove 60b is arranged exclusively in the magnet armature 18b. The coil body 10b is free of airing and/or de-airing grooves 60b. The airing and/or de-airing groove 60b forms a depression in a running surface 62b of the magnet armature 18b.

1. An electromagnet device with at least one coil body, with a magnetic coil wound on the coil body, and with a magnetic circuit comprising at least
a magnetic core,
a magnet armature supported movably relative to the magnetic core, and
a magnetic yoke unit with at least one magnet armature-side yoke part, and with at least one magnetic core-side yoke part realized separately from the magnet armature-side yoke part,
the magnet armature-side yoke part being configured to guide a magnetic flux, which can be generated by the magnetic coil, between the magnetic core-side yoke part and the magnet armature,
the electromagnet device further comprising a yoke sealing unit, in particular at least for a sealing of a movement range of the magnet armature, with at least one first sealing element bearing in a sealing manner against the magnet armature-side yoke part on a first side of the magnet armature-side yoke part, and with at least one second sealing element bearing in a sealing manner against the magnet armature-side yoke part on a second side of the magnet armature-side yoke part that is situated opposite the first side.

2. The electromagnet device according to claim 1, wherein the magnet armature-side yoke part is realized as an at least one-stepped yoke disk, preferably as a precisely one-stepped yoke disk.

3. The electromagnet device according to claim 1, wherein the first sealing element and/or the second sealing element are/is realized as a radial sealing element.

4. The electromagnet device according to claim 1, wherein in a middle region situated between two radial end regions, the magnet armature-side yoke part forms a sealing section within which the first sealing element and the second sealing element bear sealingly against the magnet armature-side yoke part.

5. The electromagnet device according to claim 4, wherein within the sealing section, surfaces of the magnet armature-side yoke part extend axially, in particular at least substantially parallel, to a movement axis of the magnet armature.

6. The electromagnet device according to claim 4, wherein within the two radial end regions, surfaces of the magnet armature-side yoke part, which are different from end edge faces of the magnet armature-side yoke part, extend radially, in particular at least substantially perpendicularly, to a movement axis of the magnet armature.

7. The electromagnet device according to claim 4, wherein within one of the two radial end regions, a surface of the magnet armature-side yoke part, which is in particular different from an end edge face of the magnet armature-side yoke part, bears against and contacts the magnet core-side yoke part.

8. The electromagnet device according to claim 4, wherein a surface of the magnet armature-side yoke part, which forms an end edge face of the magnet armature-side yoke part within one of the two radial end regions, forms a guiding surface for guiding an axial movement of the magnet armature.

9. The electromagnet device according to claim 1, wherein the magnet armature is guided directly in the coil body, and preferably without core tubes, armature guiding tubes or the like.

10. The electromagnet device according to claim 1, further comprising one or several airing and/or de-airing groove/s, which permits/permit air flowing axially past the magnet armature and which is/are sealed at least indirectly against the outside by the yoke sealing unit.

11. The electromagnet device according to claim 10, wherein one or several airing and/or de-airing groove/s, preferably all airing and/or de-airing groove/s, is/are arranged in the coil body.

12. The electromagnet device according to claim 11, wherein the one or several airing and/or de-airing groove/s is/are continued in the magnet armature-side yoke part.

13. The electromagnet device according to claim 1, wherein the magnet armature forms a cylindrical, in particular groove-free, running surface.

14. The electromagnet device according to claim 10, wherein one or several airing and/or de-airing groove/s, preferably all airing and/or de-airing groove/s, is/are arranged in the magnet armature.

15. The electromagnet device according to claim 1, wherein the magnetic core-side yoke part is realized as a U-yoke.

16. The electromagnet device according to claim 1, wherein the magnetic core comprises an axial airing and/or de-airing channel, which in particular permits an axial forwarding of air emerging from the one or several airing and/or de-airing groove/s.

17. The electromagnet device according to claim 16, further comprising a one-part de-airing cap, which permits an escape of air, emerging from the axial airing and/or de-airing channel of the magnetic core, from the electromagnet device to the outside and at the same time prevents air from entering the electromagnet device from the outside.

18. The electromagnet device according to claim 1, further comprising a magnetic core sealing unit, which seals the magnetic core towards the coil body.

19. A valve, in particular an airing and/or de-airing valve for a pneumatic system, with an electromagnet comprising an electromagnet device according to claim 1.

20. An electromagnet device with at least one coil body, with a magnetic coil wound on the coil body, and with a magnetic circuit comprising at least
a magnetic core,
a magnet armature supported movably relative to the magnetic core, and
a magnetic yoke unit with at least one magnet armature-side yoke part, and with at least one magnetic core-side yoke part realized separately from the magnet armature-side yoke part,
the magnet armature-side yoke part being configured to guide a magnetic flux, which can be generated by the magnetic coil, between the magnetic core-side yoke part and the magnet armature, wherein the magnet armature-side yoke part is realized as an at least one-stepped yoke disk, preferably as a precisely one-stepped yoke disk.
